(19) United States
(12) Patent Application Publication
(10) Pub. No.: US 2025/0041910 A1
(43) Pub. Date: Feb. 6, 2025

(54) WASTE SORTING ROBOT AND EXTERNAL CLEANING APPARATUS

(71) Applicant: MP ZenRobotics OY, Vantaa (FI)

(72) Inventor: Harri Holopainen, Espoo (FI)

(21) Appl. No.: 18/717,813

(22) PCT Filed: Dec. 9, 2022
(86) PCT No.: PCT/EP2022/085103

§ 371 Date: Jun. 7, 2024

(30) Foreign Application Priority Data
Dec. 9, 2021 (SE) 2130349-0

(51) Int. Cl. B08B 3/08; B07C 5/36; B65G 47/91

(52) U.S. Cl. CPC B08B 3/08; B07C 5/36; B65G 47/912; B07C 2501/0054; B07C 2501/0063; B65G 2207/26

(57) ABSTRACT

A waste sorting robot (100) comprises a manipulator (104) moveable within a working area (108). A suction gripper (120) is connected to the manipulator (104) and arranged to generate a negative pressure to selectively grip a waste object (106) in the working area (108). The waste sorting robot (100) further comprises a cleaning solvent supply external to the suction gripper (120). The suction gripper (120) is configured to move from a first position remote from the cleaning solvent supply to a second position wherein the cleaning solvent supply contacts the suction gripper (120).

The present invention relates to a waste sorting robot for sorting waste objects and an external cleaning apparatus.

In the waste management industry, industrial and domestic waste is increasingly being sorted in order to recover and recycle useful components. Each type of waste, or “fraction” of waste can have a different use and value. If waste is not sorted, then it often ends up in landfill or incineration which has an undesirable environmental and economic impact.

It is known to sort industrial and domestic waste using a waste sorting robot. The waste sorting robot may pick objects with a suction gripper which uses negative pressure for sucking and gripping an object to be sorted. A problem with existing suction grippers is that the waste sorting environment has a significant amount of dust and debris. This means that the suction gripper can become blocked and that the waste sorting robot must be taken offline whilst maintenance is carried out.

Examples described hereinafter aim to address the aforementioned problems.

In an aspect of the disclosure there is provided a waste sorting robot comprising: a manipulator moveable within a working area; a suction gripper connected to the manipulator and arranged to generate a negative pressure to selectively grip a waste object in the working area; and a cleaning solvent supply external to the suction gripper; wherein the suction gripper is configured to move from a first position remote from the cleaning solvent supply to a second position wherein the cleaning solvent supply contacts the suction gripper.

Optionally, the cleaning solvent supply is an open container and the suction gripper is configured to lower from the first position above the open container to a second position wherein at least part of the suction gripper is submerged in the cleaning solvent supply.

Optionally, the open container is mounted to the waste sorting robot.

Optionally, the open container is mounted to the frame of the waste sorting robot or to a chute configured to receive sorted waste objects.

Optionally, the cleaning solvent supply is in fluid communication with at least one first cleaning nozzle configured to spray cleaning solvent droplets and the suction gripper is configured to move from the first position remote from the cleaning solvent droplets to a second position in contact with the cleaning solvent droplets.

Optionally, the at least one first cleaning nozzle is configured to spray at least part of the working area.

Optionally, the at least one first cleaning nozzle is configured to spray one or more objects before the one or more objects enter the working area.

Optionally, the cleaning solvent supply is in fluid communication with at least one second cleaning nozzle configured to spray cleaning solvent droplets on one or more waste object outside the working area and the suction gripper is configured to move from the first position remote from the cleaning solvent droplets to a second position in contact with the waste object and cleaning solvent droplets.

In another aspect of the disclosure there is provided a waste sorting robot comprising: a manipulator moveable within a working area; a suction gripper connected to the manipulator and arranged to generate a negative pressure to selectively grip a waste object in the working area; and a cleaning solvent supply in fluid communication with a cleaning solvent outlet wherein the cleaning solvent outlet is mounted external to the suction gripper.

Optionally, the cleaning solvent outlet is remote from an airflow flow path inside the suction gripper.

Optionally, the cleaning solvent outlet is configured to deliver cleaning solvent to more of the manipulator, the suction gripper, and/or a conveyor.

Optionally, the cleaning solvent outlet is configured to deliver cleaning solvent to the waste object before the waste object enters the working area.

Optionally, the cleaning solvent outlet is in fluid connection with a supply valve configured to selectively supply the cleaning solvent.

Optionally, the cleaning solvent supply is a cleaning solvent tank.

Optionally, the moveable manipulator is mounted on a waste sorting robot frame and the cleaning solvent tank is mounted above the suction gripper on the waste sorting robot frame.

Optionally, cleaning solvent is water, ethanol, methanol, ammonia, and/or acetone.

Optionally, the cleaning solvent comprises one or more additives.

Optionally, the additive is one or more of a disinfectant, a surfactant, a detergent, and/or a dispersant.

In another aspect of the disclosure there is a method of controlling a waste sorting robot comprising: moving a manipulator within a working area; controlling a suction gripper connected to the manipulator to generate a negative pressure to selectively grip a waste object in the working area; and moving the suction gripper from a first position remote from a cleaning solvent supply to a second position; supplying the suction gripper with the cleaning solvent supply when the suction gripper is in the second position such that the cleaning solvent supply contacts the suction gripper.

In another aspect of the disclosure there is a method of controlling a waste sorting robot comprising: moving a manipulator within a working area; controlling a suction gripper connected to the manipulator to generate a negative pressure to selectively grip a waste object in the working area; and supplying the suction gripper with a cleaning solvent from a cleaning solvent outlet in fluid communication with a cleaning solvent supply wherein the cleaning solvent outlet is mounted external to the suction gripper.

In another aspect of the disclosure there is a cleaning apparatus for a waste sorting robot having a manipulator moveable within a working area and a suction gripper connected to the manipulator and arranged to generate a negative pressure to selectively grip a waste object in the working area, the cleaning apparatus comprising: a frame; a cleaning solvent outlet mounted to the frame and in fluid communication with a cleaning solvent supply; wherein the cleaning solvent outlet is configured to direct the cleaning solvent towards an exterior surface of the suction gripper.

Various other aspects and further examples are also described in the following detailed description and in the attached claims with reference to the accompanying drawings, in which:

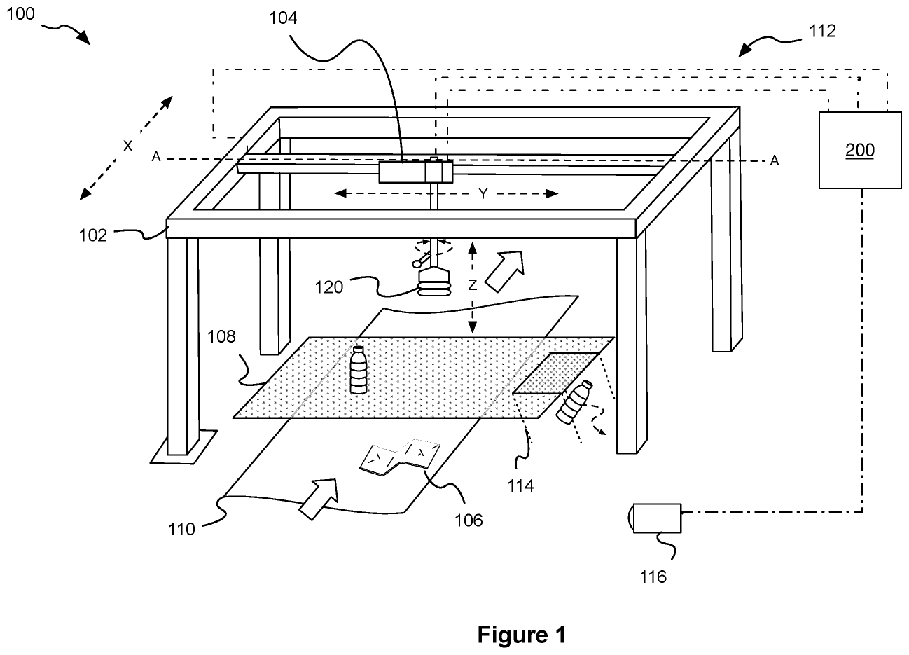

FIG. 1 shows a schematic perspective view of a waste sorting robot and cleaning apparatus according to an example;

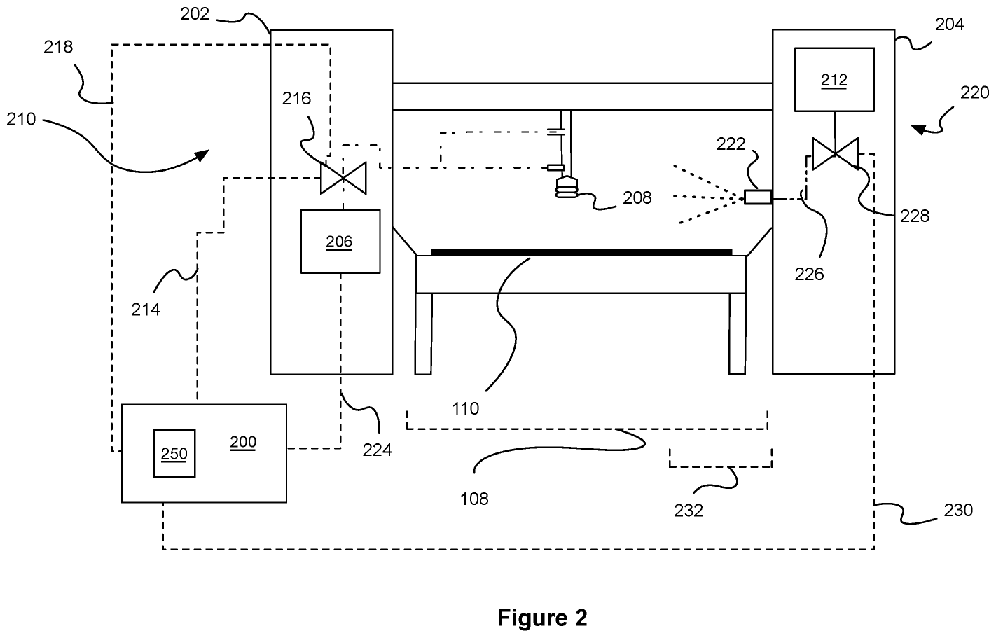

FIG. 2 shows a schematic front view of a waste sorting robot and cleaning apparatus according to an example;

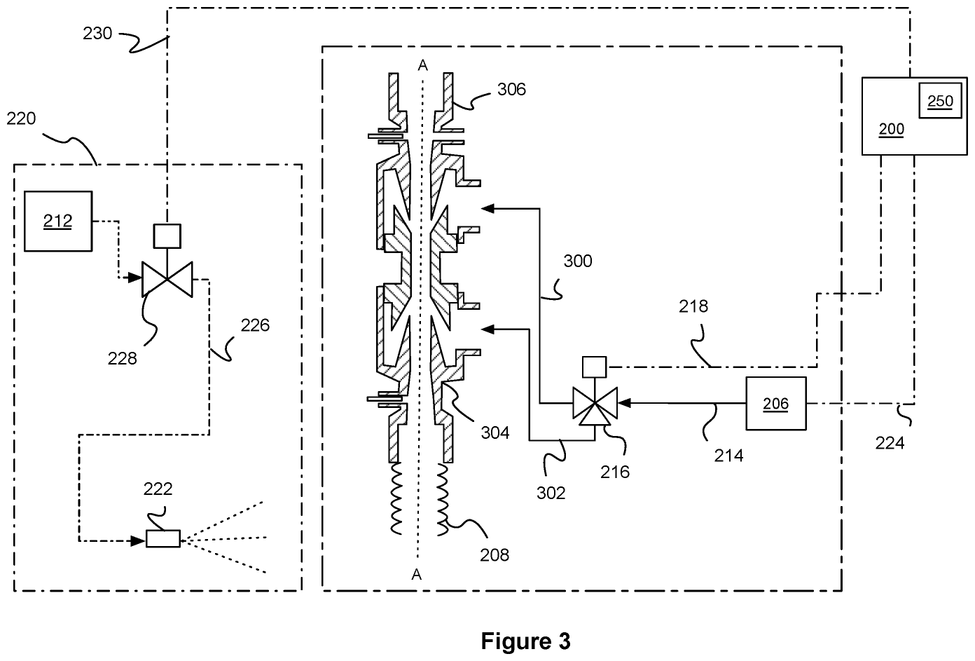

FIG. 3 shows a schematic cross-sectional view of a suction gripper and cleaning apparatus according to an example;

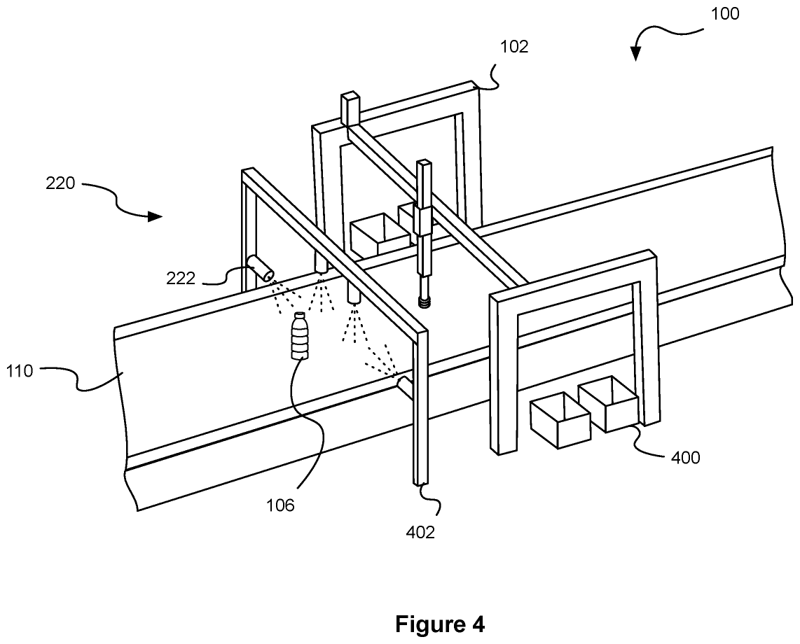

FIG. 4 shows a perspective view of a waste sorting robot and cleaning apparatus according to an example;

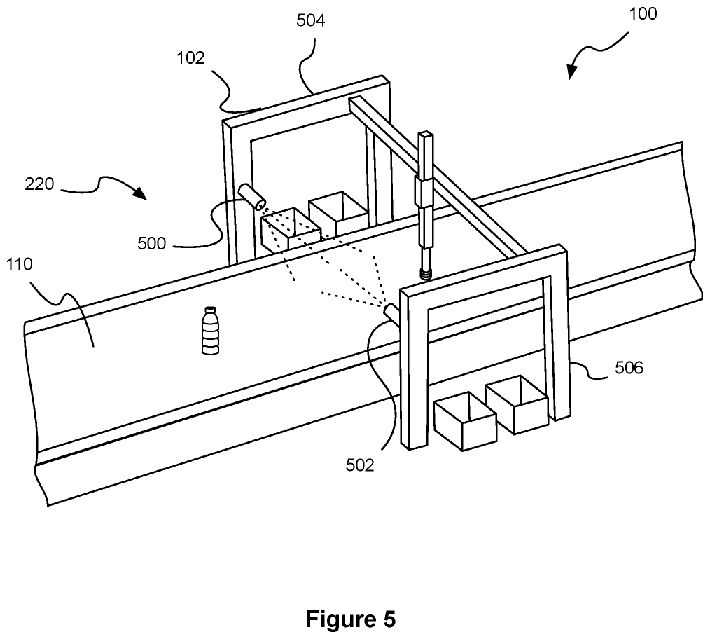

FIG. 5 shows a perspective view of a waste sorting robot and cleaning apparatus according to an example;

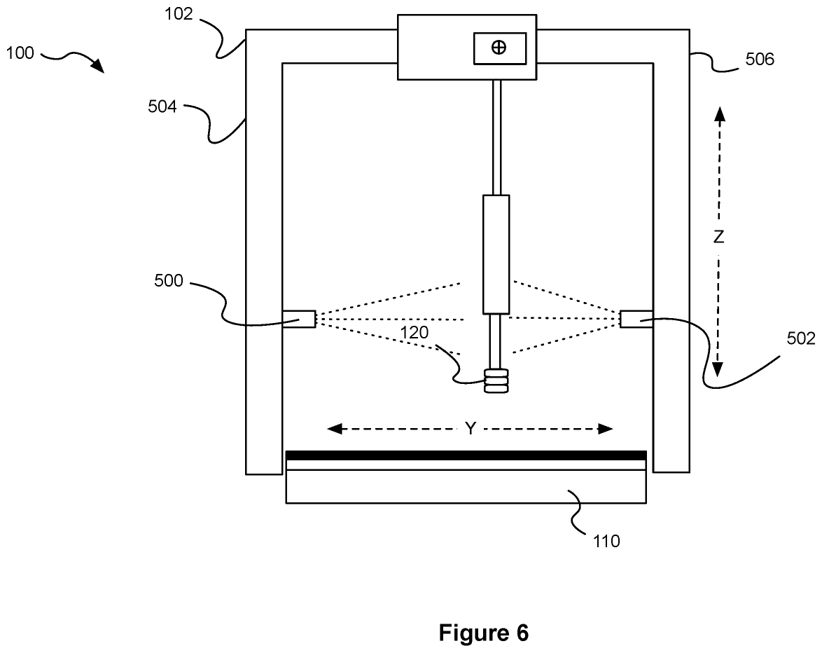

FIG. 6 shows a side view of a waste sorting robot and cleaning apparatus according to an example according to an example;

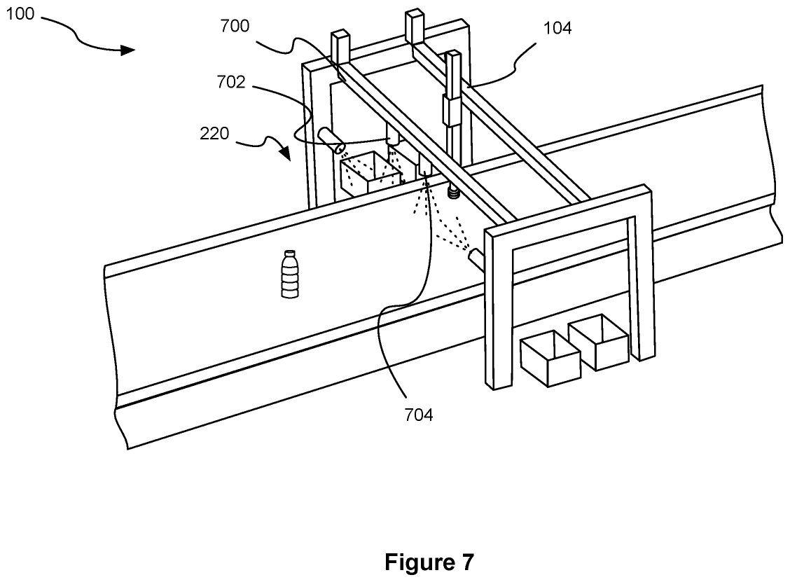

FIG. 7 shows a perspective view of a waste sorting robot and cleaning apparatus according to an example;

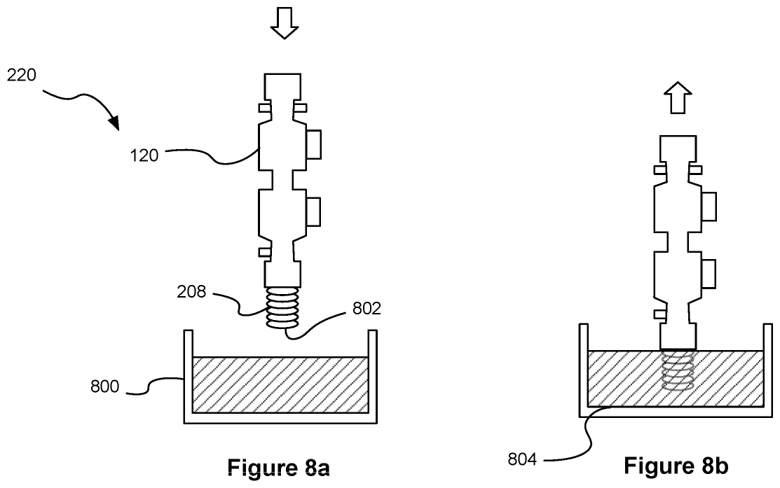

FIGS. 8a and 8b show schematic side views of a suction gripper and cleaning apparatus according to an example in different positions;

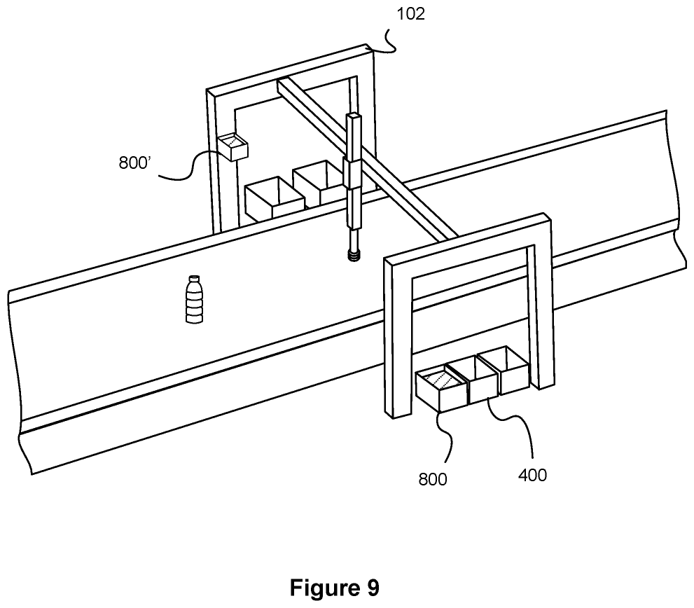

FIG. 9 shows a perspective view of a waste sorting robot and cleaning apparatus according to an example;

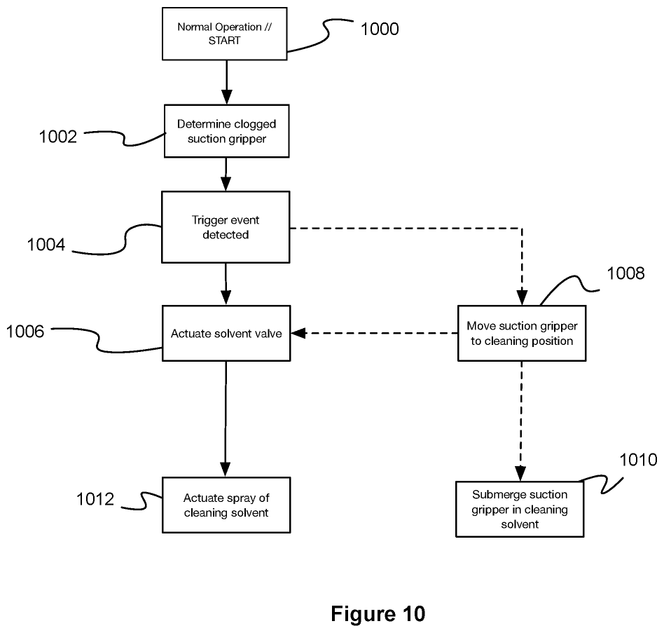

FIG. 10 shows a flow diagram for operation of a waste sorting robot and cleaning apparatus according to an example.

FIG. 1 shows a perspective view of a waste sorting robot 100. In some examples, the waste sorting robot 100 can be a waste sorting gantry robot 100. In other examples other types of waste sorting robots can be used. For the purposes of brevity, the examples will be described in reference to waste sorting gantry robots but the examples described below can be used with other types of robot such as robot arms or delta robots. In some other examples, the waste sorting robot 100 is a Selective Compliance Assembly Robot Arm (SCARA).

The waste sorting robot 100 comprises a controller 200 (schematically shown in FIGS. 2 and 3) for sending control and movement instructions to a manipulator 104 for interacting with a waste object 106 to be sorted. For the purposes of clarity, only one waste object 106 is shown in FIG. 1 but there can be any number of waste objects 106 moving past the waste sorting robot 100.

The combination of the controller 200 sending control instructions to the manipulator 104 can also be referred to as a “robot”. The controller 200 is located remote from the manipulator 104 and in some examples is housed in first and second cabinets 202, 204 (best shown in FIG. 2). In other examples, the controller 200 can be integral with the manipulator 104 and/or a frame 102. In some examples, part of the frame 102 is housed in the first and second cabinets 202, 204 for shielding one or more components of the waste sorting robot 100. In some examples, the frame 102 can be a gantry frame, but in other examples, the frame 102 can be any suitable structure for mounting the manipulator 104. Any of the waste sorting robots 100 discussed hereinafter with reference to the other Figures can optionally comprise a first and/or second cabinet 202, 204 as shown in FIG. 2.

The manipulator 104 physically engages and moves the waste object 106 that enters a working area 108 on a conveyor 110 such as a moveable belt in order to sort the waste object 106. The working area 108 of a manipulator 104 is an area within which the manipulator 104 is able to reach and interact with the waste object 106. The working area 108 as shown in FIG. 1 is a partially shaded area beneath the manipulator 104.

The manipulator 104 is configured to move at variable heights above the working area 108. In this way, the manipulator 104 is configured to move within a working volume defined by the height above the working area 108 where the robot can manipulate the waste object 106. Hereinafter, the term working area 108 also refers to the space above the conveyor 110 for the purposes of brevity. The manipulator 104 comprises one or more components for effecting relative movement with respect to the waste object 106. The manipulator 104 will now be described in further detail.

As shown in FIG. 1, the manipulator 104 is configured to move within the working area 108. The manipulator 104 comprises one or more servos, pneumatic actuators or any other type of mechanical actuator for moving the manipulator 104 in one or more axes. For the purposes of clarity, the servos, pneumatic actuators or mechanical actuators are not shown in FIG. 1.

In some examples, the manipulator 104 is moveable along a plurality of axes. In some examples, the manipulator 104 is moveable along three axes which are substantially at right angles to each other. In this way, the manipulator 104 is movable in an X-axis which is parallel with the longitudinal axis of the conveyor 110. Additionally, the manipulator 104 is movable across the conveyor 110 in a Y-axis which is perpendicular to the longitudinal axis of the conveyor 110. The manipulator 104 is movable in a Z-axis which is in a direction normal to the working area 108 and the conveyor 110. Optionally, the manipulator 104 can rotate about one or more axes. In some examples, a suction gripper 120 is coupled to the manipulator 104. Optionally, the suction gripper 120 can rotate about a rotation axis. The suction gripper 120 is discussed in further detail below.

The servos, pneumatic actuators or mechanical actuators are connectively connected to the controller 200 and the controller 200 is configured to issue instructions for actuating one or more of the servos, pneumatic actuators or mechanical actuators to move the manipulator 104 within the working area 108. Connections 112 between the servos, pneumatic actuators or mechanical actuators and the controller 200 can comprise one or more data and/or power connections 112. The control of servos, pneumatic actuators or mechanical actuators to move of the manipulator 104 is known and will not be discussed any further.

The waste object 106 is moved into the working area 108 by the conveyor 110. The path of travel of the conveyor 110 intersects with the working area 108. The direction of the conveyor 110 is shown in FIG. 1 by two arrows. This means the waste object 106 moving on the conveyor 110 will pass through the working area 108. The conveyor 110 can be a continuous belt, or a conveyor belt formed from overlapping portions. The conveyor 110 can be a single belt or alternatively a plurality of adjacent moving belts (not shown).

In other examples, the waste object 106 can be conveyed into the working area 108 via other conveying means. The conveyor 110 can be any suitable means for moving the waste object 106 into the working area 108. For example, the waste object 106 are fed under gravity via a slide (not shown) to the working area 108.

The waste object 106 can be any type of industrial waste, commercial waste, domestic waste or any other waste which requires sorting and processing. Unsorted waste material comprises a plurality of fractions of different types of waste. Industrial waste can comprise fractions, for example, of metal, wood, plastic, hardcore and one or more other types of waste. In other examples, the waste can comprise any number of different fractions of waste formed from any type or parameter of waste. The fractions can be further subdivided into more refined categories. For example, metal can be separated into steel, iron, aluminium etc. Domestic waste also comprises different fractions of waste such as plastic, paper, cardboard, metal, glass and/or organic waste. A fraction is a category of waste that the waste can be sorted into by the waste sorting robot 100. A fraction can be a standard or homogenous composition of material, such as aluminium, but alternatively a fraction can be a category of waste defined by a customer or user.

The waste sorting robot 100 is arranged to sort the waste object 106 into fractions according to one or more parameters of the waste object 106. The controller 200 receives information from the at least one sensor 116 corresponding to the waste object 106 on the conveyor 110. The at least one sensor 116 is positioned in front of the manipulator 104 so that detected measurements of the waste object 106 are sent to the controller 200 before the waste object 106 enters the working area 108. In some examples, the at least one sensor 116 can be any sensor suitable for determining a parameter of the waste object 106 e.g. one or more of a RGB camera, an infrared camera, a metal detector, a hall sensor, a temperature sensor, visual and/or infrared spectroscopic detector, 3D imaging sensor, terahertz imaging system, radioactivity sensor and/or a laser e.g. LIDAR.

The controller 200 determines instructions for moving the manipulator 104 based on the received information according to one or more criteria. Various information processing techniques can be adopted by the controller 200 for controlling the manipulator 104. Such information processing techniques are described in WO2012/089928, WO2012/052615, WO2011/161304, WO2008/102052 which are incorporated herein by reference. Techniques for sorting the waste object 106 are known and will not be discussed any further.

Once the waste object 106 has been sorted into a fraction, the waste object 106 can be moved or thrown to a chute 114 adjacent to the conveyor 110. In some examples, the chute 114 can be replaced with a receptacle 400 (as best shown in FIG. 4) configured to receive sorted waste objects 106. Alternatively, the chute 114 can be replaced with a hole in the floor for creating a pile of sorted waste objects 106 beneath the waste sorting robot 100.

The mix of waste products means that the environment of the waste sorting robot 100 can be particularly dirty. For example the conveyor 110 can be dusty and be covered with debris. This means that the waste sorting robot 100 operates in a challenging environment and maintenance must be regularly carried out on parts of the waste sorting robot 100 such as the manipulator 104. Furthermore, often such types of waste objects 106 can comprise organic matter. For example, domestic waste objects 106 can comprise residual waste food. This is often sticky and can adhere to parts of the waste sorting robot 100. Mitigation of the dirt contaminating the waste sorting robot 100 will described in more detail below.

The waste sorting robot 100 will now be described further in reference to FIG. 2. FIG. 2 shows a schematic front view of the waste sorting robot 100. The suction gripper 120 comprises a suction cup 208 for physically engaging with a surface of the waste object 106.

The suction gripper 120 is in fluid communication with a pneumatic system 210. The pneumatic system 210 comprises at least a first air hose 214 for connecting the suction gripper 120 to a compressed air supply. For the purposes of clarity, only a first air hose 214 is shown in FIG. 2 connecting the suction gripper 120 to the compressed air supply but there can be any number of air hoses connected between the suction gripper 120 and the compressed air supply. For example, there can optionally be at least a second air hose connecting the suction gripper 120 to the compressed air supply. In this way, a second source of air is provided to the suction gripper 120. In some examples, the compressed air supply is configured to be used to create a suction force in the suction gripper 120 e.g., creating a vacuum source using the Venturi principle. This is described in further in detail in SE1930130 which is incorporated herein by reference.

Exemplary pneumatic connections in the pneumatic system 210 will be further discussed in reference to FIGS. 2 and 3. FIG. 3 shows a schematic cross-sectional view of a suction gripper 120 and cleaning. In some examples, the first air hose 214 can be connected to a plurality of downstream air hoses 300, 302 (as shown in FIG. 3) for supplying compressed air to a plurality of pneumatic components in the pneumatic system 210. For example, the first air hose 214 is a single, unitary air hose mounted on the manipulator 104. By providing only one main first air hose 214 which is mounted on the manipulator 104 to the suction gripper 120, installation and maintenance of the waste sorting robot 100 can be simplified. The first air hose 214 is flexible and mounted to the frame 102 and/or the manipulator 104. The first air hose 214 is sufficiently flexible to move and flex so as to change shape as the manipulator 104 moves without impeding the movement of the manipulator 104.

The pneumatic system 210 comprises an air compressor 206 for generating a source of compressed air. Optionally, the pneumatic system 210 can also comprise an air storage tank (not shown) for compressed air. Furthermore, the pneumatic system 210 can also comprise one or more pneumatic valves 216 for selectively providing air to the suction gripper 120. In this way, pneumatic system 210 comprises air supply such as air compressor 206 in fluid connection to the suction gripper 120 configured to generate an airflow along an airflow path between the air supply e.g. the air compressor 206 and the suction gripper 120. In other examples, the air supply can be provided by any suitable source of compressed air or compressed gas.

In some examples, the first air hose 214 is connected to a first downstream supply air hose 300 and a second downstream supply air hose 302. The first air hose 214 is connected to the first downstream supply air hose 300 and a second downstream supply air hose 302 via the pneumatic valve 216. This means the compressed air supplied to either the first downstream supply air hose 300 or the second downstream supply air hose 302 from the first air hose 214. However, different alternative arrangements of hoses and valves can be provided to supply compressed air to the suction gripper 120.

The pneumatic system 210 is schematically shown as being located within the first cabinet 202. However, in other examples the pneumatic system 210 can be partially or wholly located remote from the waste sorting robot 100. For example, there may be a plurality of waste sorting robots 100 on a sorting line (not shown) each of which require a source of air. In this way, a single air compressor 206 can be connected to a plurality of waste sorting robots 100 via a plurality of air hoses 202, 300, 302. Accordingly, the pneumatic system 210 may be located between waste sorting robots 100.

In some examples the plurality of air hoses 202, 300, 302 can be alternatively replaced with one or more vacuum hoses (not shown) connected to a vacuum source. Accordingly, suction gripper 120 can be connected to a vacuum hose rather than an air hose. Using the suction gripper 120 with a vacuum hose connected to a vacuum source is known and will not be discussed in any more detail.

Operation of the pneumatic system 210 is controlled by the controller 200. The controller 200 is connected via pneumatic control lines 218, 224 to the pneumatic system 210, the air compressor 206 and the pneumatic valve 216. The controller 200 is configured to send control instructions to the pneumatic system 210, the air compressor 206, and the pneumatic valve 216. This means that the controller 200 can selectively operate e.g. the air compressor 206 or the pneumatic valve 216 to deliver a supply of air to the suction gripper 120.

The waste sorting robot 100 as shown in FIG. 2 also comprises a cleaning apparatus 220. The cleaning apparatus 220 is configured to supply a cleaning solvent to one or more external parts of the waste sorting robot 100. The cleaning apparatus 220 can be independent from the waste sorting robot 100. This means that the cleaning apparatus 220 is controlled independently from the waste sorting robot 100. The cleaning apparatus 220 can be remote from the waste sorting robot 100. However, the cleaning apparatus 220 can be integrated with the waste sorting robot 100 and controlled by the controller 200. Examples of independent and integrated cleaning apparatus 220 and waste sorting robot 100 will be discussed below.

The cleaning apparatus comprises a cleaning solvent supply such as cleaning solvent tank 212 for dissolving organic matter or other dirt dried onto the suction gripper 120 or other parts of the pneumatic system 210.

In some examples the cleaning apparatus 220 optionally comprises a cleaning solvent outlet 222 configured to supply the cleaning solvent. In some other examples, the cleaning solvent supply is alternatively or additionally a pipe (not shown) in fluid communication with a cleaning solvent outlet 222. For example the pipe can be a pipe for feeding cleaning solvent e.g. a mains water pipe. This means that the waste sorting robot 100 always connected to a cleaning solvent supply and the cleaning solvent tank 212 does not have to be replenished. The waste sorting robot 100 can be installed in a remote location and it may not be possible to connect the waste sorting robot 100 to a mains water supply.

In some examples, the cleaning solvent is water, but in other examples the cleaning solvent can be ethanol, methanol, ammonia, acetone or any other suitable cleaning solvent for dissolving organic matter or other dirt dried to the waste sorting robot 100. In a preferred example, the cleaning solvent is water because it is easier for the operator to handle water than other cleaning solvents. However, there may be certain types of waste objects that contaminate the waste sorting robot 100 with dirt that is not easily removed with water. For example, silicone sealant tubes may contaminate the waste sorting robot 100 with silicone sealant. Silicone sealant may require another cleaning solvent other than water for successful removal. The term “cleaning solvent” will be used to describe the examples and refer to any suitable fluid for dissolving or removing dirt and debris stuck to the surfaces of the waste sorting robot 100.

In some examples, the cleaning solvent can optionally comprise one or more additives. In some examples one or more of a disinfectant, surfactant, detergent, dispersant is added to the cleaning solvent to help removal of dirt from the waste sorting robot 100.

The cleaning solvent outlet 222 is in fluid connection with the cleaning solvent tank 212. The cleaning solvent outlet 222 is positioned external to the internal airflow path of the suction gripper 120. This means that the cleaning solvent outlet 222 does not apply cleaning solvent to the inside of the suction gripper 120. Instead, the cleaning solvent is supplied to the exterior of one or more parts of the waste sorting robot 100. This makes installation and maintenance of the cleaning apparatus 220 easier for the user.

Advantageously, it has been realized that dosing the airflow within the suction gripper 120 is not necessary in order to clean the inside of the suction gripper 120. Indeed, during operation of the suction gripper 120, droplets of cleaning solvent will be gradually sucked into the inside of the suction gripper 120. This means that the internal surfaces of the suction gripper 120, the suction cup 208 and other internal components such as filters are kept moist even when the cleaning solvent is supplied to the external surfaces of the waste sorting robot 100 and the suction gripper 120. The amount of cleaning solvent required to dislodge the organic matter can be provided if the cleaning solvent is supplied to the waste sorting robot remote from the suction gripper 120 or external to the suction gripper 120.

Similar to the pneumatic system 210, the cleaning apparatus 220 comprises a cleaning solvent hose 226 in fluid communication between the cleaning solvent outlet 222 and the cleaning solvent tank 212. In some examples, the cleaning solvent hose 226 is mounted on the manipulator 104. The cleaning solvent hose 226 is flexible and mounted to the frame 102 and/or the manipulator 104. The cleaning solvent hose 226 is sufficiently flexible to move and flex so as to change shape as the manipulator 104 moves without impeding the movement of the manipulator 104.

In some examples, the cleaning solvent tank 212 can comprise a pump (not shown) for urging the cleaning solvent from the cleaning solvent tank 212 to the cleaning solvent outlet 222. In some examples, the cleaning solvent tank 212 can be pressurised and no pump is required. For example, a third air hose (not shown) and another pneumatic valve (not shown) can be coupled to the cleaning solvent tank 212 for pressurising the cleaning solvent in the cleaning solvent tank 212. In this way, the controller 200 can selectively control pressurising the cleaning solvent tank 212 to control the flow of the cleaning solvent to the cleaning solvent outlet 222. Alternatively, the cleaning solvent tank 212 is mounted on the frame 102 in a position above the suction gripper 120. This means that the cleaning solvent will be fed to the cleaning solvent outlet 222 via gravity alone.

In some examples, a supply pump can be in fluid communication with the cleaning solvent tank 212 which enables precise control of the amount of liquid injected. In some examples the supply pump is a peristatic pump but in other examples other pumps can be used such as diaphragm pumps, piston pumps, nutating pumps, flexible-van pumps, lobed pumps, gear pumps, diffuser pumps or any other suitable means for dosing the cleaning solvent. The supply pump is configured to suck the cleaning solvent from the cleaning solvent tank 212. The inventors have realized that the dosing pump can be provided without the need for separate valve. Accordingly, the supply pump can pump the cleaning solvent from the cleaning solvent tank 212, but the cleaning solvent tank 212 will not leak when the dosing pump is not in operation.

In some examples, the cleaning apparatus 220 and the cleaning solvent tank 212 are mounted in the first cabinet 202 or the second cabinet 204 and easily accessible to an operator. The cleaning solvent tank 212 can optionally have a transparent window in a wall of the cleaning solvent tank 212 or the wall of the cleaning solvent tank 212 can be translucent. This means that the operator can visually inspect the amount of cleaning solvent left in the cleaning solvent tank 212.

In some other examples, the cleaning apparatus 220 is mounted to a separate cleaning frame 402 (as shown in FIG. 4). The cleaning frame 402 is a separate structure from the frame 102 of the waste sorting robot 100. This means that the cleaning frame 402 can be installed on an existing waste sorting robot 100. This means the cleaning frame 402 and the cleaning apparatus 220 is retrofittable. The cleaning frame 402 will be described in further detail in reference to FIG. 4 below.

Turning back to FIG. 2, the cleaning apparatus 220 will be discussed in more detail. A cleaning solvent valve 228 is arranged to selectively control a flow of cleaning solvent to the cleaning solvent outlet 222. Operation of the cleaning apparatus 220 supplying cleaning solvent in some examples is optionally controlled by the controller 200. The controller 200 is optionally connected via cleaning solvent control line 230 to the cleaning solvent valve 228. In some examples, the controller 200 is configured to send control instructions to cleaning solvent valve 228. This means that the controller 200 can selectively operate the cleaning solvent valve 228 to deliver a supply of cleaning solvent to the cleaning solvent outlet 222 mounted on the suction gripper 120.

In some examples the cleaning solvent outlet 222 is at least one cleaning solvent nozzle 222. The cleaning solvent nozzle 222 is configured to spray droplets or a fine mist of the cleaning solvent over one or more parts of the waste sorting robot 100. For example, as shown in FIG. 2, the cleaning solvent nozzle 222 is configured to spray droplets of the cleaning solvent over the suction gripper 120 or the suction cup 208.

In some examples, the at least one cleaning solvent nozzle 222 is configured to direct cleaning solvent to at least part 232 of the working area 108. The part 232 of the working area 108 which is sprayed by the cleaning solvent nozzle 222 is also known as the cleaning zone 232. As shown in FIG. 2, the cleaning solvent nozzle 222 is configured to spray the right-hand side of the conveyor 110. This means that the cleaning solvent nozzle 222 is configured to spray the suction gripper 120 whenever the suction gripper 120 moves within the part 232 of the working area 108. The controller 200 is configured to move the suction gripper 120 within the effective area of the cleaning zone 232. In some examples, the controller 200 can move the suction gripper 120 within the cleaning zone 232 periodically. In some examples, the controller 200 can move the suction gripper 120 within the cleaning zone 232 on receipt of a manual instruction from a user. In some examples, the controller 200 can move the suction gripper 120 within the cleaning zone 232 when the controller 200 determines that there is a build-up of residue on the suction gripper 120.

Whilst FIG. 2 shows a cleaning zone 232 overlaps with part of the working area 108, in other examples the cleaning zone 232 overlaps with the entire working area 108. Alternatively, in other examples, the cleaning zone 232 does not overlap at all with the working area 108. The different locations of the cleaning zone 232 with respect to the working area 108 will be discussed in more detail below.

Optionally, there is no cleaning solvent valve 228 and the cleaning solvent is constantly fed to the cleaning solvent outlet 222. A constant supply of cleaning solvent supplied to the cleaning solvent outlet 222 can increase the quality of the seal made between the suction cup 208 and the surface of the waste object 106. In some examples, there is no cleaning solvent valve 228 and no cleaning solvent pump. In this case, the cleaning solvent is constantly fed to the suction gripper 120 e.g., drip fed under gravity. For example, the cleaning solvent outlet 222 is mounted on the outside of the suction gripper 120 and the cleaning solvent outlet 222 constantly drip feeds cleaning solvent over the outside of the suction cup 208 during operation. This means that the cleaning solvent outlet 222 can be easily retrofittable to an existing suction gripper 120 on an installed waste sorting robot 100.

In some examples with a cleaning solvent valve 228, the controller 200 is configured to actuate the cleaning solvent valve 228 to modify the flow rate of the cleaning solvent to the cleaning solvent outlet 222. This means that the controller 200 can adjust the cleaning solvent flow rate if the waste sorting robot 100 is particularly dirty. In some examples, the controller 200 can adjust the flow rate of the cleaning solvent in dependence on a dirt parameter of the waste sorting robot 100. This means the cleaning solvent outlet 222 can increase the amount of cleaning solvent sprayed onto the suction gripper 120. An operator can manually input information relating to the dirt parameter relating to the cleanliness of the waste sorting robot 100. Additionally or alternatively, the controller 200 can optionally receive and analyse images of the suction cup 208 to determine whether the suction cup 208 is soiled with dried dirt e.g. dried organic matter.

In some examples, any type of suction gripper 120 can be used to grip the waste object 106. In some examples, as shown in FIG. 3, the suction gripper 120 comprises an integrated suction tube 304 and blow tube 306 for carrying out grip/pick operations and throwing operations. One such known suction gripper 120 is discussed in SE201830137 which is incorporated herein by reference. This type of suction gripper 120 will not be discussed any further. Alternatively, the suction gripper 120 only comprises a suction tube 304 configured to suck and grip the waste object 106.

The cleaning apparatus 220 will now be discussed in reference to FIG. 4. FIG. 4 shows a perspective view of the waste sorting robot 100 and the cleaning apparatus 220 according to an example. FIG. 4 shows the cleaning apparatus 220 mounted on the cleaning frame 402 remote from the frame 102 of waste sorting robot 100. As discussed above, the cleaning frame 402 is separate from the waste sorting robot 100 and this means that the cleaning apparatus 220 can be retrofittable to existing waste sorting robots 100. The cleaning frame 402 can be any shape and size to fit around the conveyor 110. The cleaning frame 402 can be mounted to the floor, walls or ceilings near the waste sorting robot 100.

The cleaning apparatus 220 comprises a plurality of cleaning solvent outlets 222 mounted to the cleaning frame 402. FIG. 4 shows four cleaning solvent outlets 222 mounted at different positions on the cleaning frame 402. For the purposes of clarity, only one of the cleaning solvent outlets 222 has been labelled. The four cleaning solvent outlets 222 each comprise a cleaning solvent nozzle 222 configured to spray the entire width of the conveyor 110. The cleaning solvent outlets 222 are the same as previously described in reference to FIGS. 2 and 3. However, the cleaning apparatus 220 in some examples may be configured to spray only part 232 of the conveyor 110.

Whilst four cleaning solvent outlets 222 are shown in FIG. 4, there can be any suitable number of cleaning solvent outlets 222 as required. This means that the waste object 106 is sprayed with the cleaning solvent by the cleaning solvent outlets 222. This means that at least a portion of the waste object 106 is coated with the cleaning solvent when the waste object 106 enters the working area 108. When the suction gripper 120 picks up the waste object 106, some of the cleaning solvent on the waste object 106 will be sucked into suction gripper 120. This means that normal operation of the waste sorting robot 100 can continually clean the suction gripper 120.

In some examples, the cleaning solvent outlets 222 are constantly coating the waste objects 106 with cleaning solvent. In other examples, the cleaning solvent outlets 222 are selectively actuated by the controller 200 as previously described. In some other examples, the cleaning apparatus 220 is controlled independently of the waste sorting robot 100. For example, the cleaning apparatus 220 comprises a timer function that periodically actuates the cleaning solvent outlets 222. In some examples, the cleaning apparatus 220 operates for 300 seconds every hour.

FIG. 4 shows a receptacle 400 for received the sorted waste object 106. However, in some other examples, the receptacle 400 can be replaced with a chute 114 or hole in the floor as previously discussed in reference to FIGS. 1, 2 and 3.

In some examples the cleaning apparatus 220 is configured to supply cleaning solvent to the cleaning solvent outlets 222 when the conveyor 110 is operational. In this way the cleaning solvent is only supplied when the waste sorting robot 100 is operating under normal conditions.

In some examples the cleaning apparatus 220 comprises a water hose configured to spray water over the conveyor 110. If the amount of cleaning solvent supplied to the conveyor 110 is too much, in some examples, the waste sorting robot 100 comprises a drier configured to direct a dry airflow to one or more of the conveyor 110, the waste object 106, the manipulator 104, the suction gripper 120 or any other part of the waste sorting robot 100.

Another example will now be discussed in reference to FIGS. 5 and 6. FIG. 5 shows a perspective view of the waste sorting robot 100 and the cleaning apparatus 220 according to an example. FIG. 6 shows a side view of the waste sorting robot 100 and cleaning apparatus 220 as shown in FIG. 5. The waste sorting robot 100 as shown in FIG. 5 is the same as shown in FIG. 4 except that the cleaning apparatus 220 is mounted in a different position.

The cleaning apparatus 220 as shown in FIG. 5 is mounted on the waste sorting robot 100. In this case, a first cleaning solvent outlet 500 and a second cleaning solvent outlet 502 are mounted to the frame 102. The first and second cleaning solvent outlets 500, 502 are the same as the previously described cleaning solvent outlets 222. The first and second cleaning solvent outlets 500, 502 are mounted respectively on a first side 504 and a second side 506 of the frame 102. Each of the first and second cleaning solvent outlets 500, 502 are configured to spray the cleaning solvent towards the centre of the conveyor 110.

In some examples, the first and second cleaning solvent outlets 500, 502 are configured to spray the cleaning solvent on the waste object 106 in front of the working area 108. Additionally, or alternatively, the first and second cleaning solvent outlets 500, 502 are configured to spray the cleaning solvent within the working area 108. This means that the first and second cleaning solvent outlets 500, 502 are configured to spray the suction gripper 120 additionally or alternatively to the waste object 106. In some examples, the first and second cleaning solvent outlets 500, 502 are configured to spray the suction gripper 120 whilst the manipulator 104 is idling e.g., between picking operations. In this way, the controller 200 can issue control instructions to move the suction gripper 120 to a position within the cleaning zone 232 whereby the first and second cleaning solvent outlets 500, 502 spray the suction gripper 120 when the manipulator 104 is not performing picking operations.

In some examples, the first and second cleaning solvent outlets 500, 502 are pressure washer jets directed to the suction gripper 120.

The controller 200 can control the suction gripper 120 to move into the spray as needed to clean the suction gripper 120.

Another example will now be discussed in reference to FIG. 7. FIG. 7 shows a perspective view of the waste sorting robot 100 and the cleaning apparatus 220 according to an example. The waste sorting robot 100 and cleaning apparatus 220 is the same as shown in FIG. 5 except the cleaning apparatus 220 comprises third and fourth cleaning solvent outlets 702, 704. The frame 102 comprises a cross beam 700 mounted in front of the manipulator 104. The cross beam 700 is mounted on the frame 102 such that the manipulator 104 does not collide with the cross beam 700 during operation. A third and fourth cleaning solvent outlets 702, 704 are mounted on the cross beam 700. The third and fourth cleaning solvent outlets 702, 704 are configured to spray cleaning solvent down towards the conveyor 110. Similar to the examples shown in FIG. 5, the third and fourth cleaning solvent outlets 702, 704 are configured to spray cleaning solvent in front and/or within the working area 108. In some examples, only the third and fourth cleaning solvent outlets 702, 704 are mounted on the cross beam 700 and no other cleaning solvent outlets are mounted on the frame 102.

Reference will now be made to FIGS. 8a, 8b and 9 in order to discuss another example in more detail. FIGS. 8a and 8b show schematic side views of the suction gripper 120 and cleaning apparatus 220 according to an example in different positions. FIG. 9 shows a perspective view of the waste sorting robot 100 and the cleaning apparatus 220.

In some alternative examples, there is a cleaning solvent container 800 and the suction gripper 120 is configured to move from a first position (as shown in FIG. 8a) remote from the cleaning solvent container 800 to a second position (as shown in FIG. 8b) where the suction gripper 120 is at least partially submerged in the cleaning solvent in the cleaning solvent container 800. FIG. 8b shows that the suction cup 208 is entirely submerged in cleaning solvent in the cleaning solvent container 800. However, in some other examples, the suction cup 208 can be partially submerged or just the rim 802 of the suction cup 208 can be submerged.

In some examples, the suction gripper 120 is lowered in to the cleaning solvent container 800 so that the suction cup 208 engages the bottom surface 804 of the cleaning solvent container 800 when the suction gripper 120 is in the second position. This means that the suction gripper 120 will always contact the cleaning solvent in the second position even if some of the cleaning solvent evaporates from the cleaning solvent container 800.

The cleaning solvent container 800 is an open container configured to receive all or part of the suction gripper 120. The cleaning solvent container 800 can comprise any suitable shape configured to both receive the suction gripper 120 and hold the cleaning solvent.

When the suction gripper 120 is immersed in the cleaning solvent in the cleaning solvent container 800, the cleaning solvent contacts the external surface of the suction cup 208 and the suction gripper 120. This helps clean the suction gripper 120. After the suction gripper 120 is moved back to the first position, the suction gripper 120 continues performing picking operations. Similar to the other examples, during use of the suction gripper 120, the cleaning solvent will be entrained in the air flow of the suction gripper 120 be sucked inside the suction gripper 120. This means that the suction gripper 120 will be cleaned by the cleaning solvent during normal operation of the suction gripper 120.

The cleaning solvent container 800 is located within the working area 108. This means that the suction gripper 120 can be submerged in the cleaning solvent. The cleaning solvent container 800 can be positioned adjacent to the chutes 114 or the receptacle 400. Alternatively, the cleaning solvent container 800′ can be mounted to the frame 102 as shown in FIG. 9. The cleaning solvent container 800′ can be mounted to any part of the frame 102 such that the cleaning solvent container 800′ is located within the working area 108.

Reference will now be made to FIG. 10. FIG. 10 shows an optional flow diagram view of a method used by the waste sorting robot 100. The controller 200 determines that the manipulator 104 should carry out a pick operation and the method for cleaning the suction gripper 120 starts as show in step 1000. The controller 200 then sends control instructions to the manipulator 104 and the suction gripper 120 to carry out a pick operation.

During or after the pick operation, the controller 200 determines whether a trigger for dosing the suction gripper 120 has been detected as shown in step 1004. In some other examples, the controller 200 determines whether the trigger for cleaning the suction gripper 120 has been detected as shown in step 1002 before the suction gripper 120 is operated.

In some examples, the operator manually indicates to the controller 200 that the suction gripper 120 should be cleaned with the cleaning solvent. The operator can send an instruction to the controller 200 by pushing a button on the waste sorting robot 100 or inputting information at a user terminal. For example, the operator can instruct the controller 200 to carry out a cleaning solvent dosing operation during a maintenance procedure.

In some other examples, the controller 200 determines that a timer has expired after a predetermined period of time. For example, the controller 200 has determined that 1 hour has passed since the last cleaning solvent dosing operation. In other examples, the timer can be for any period of time e.g. 1 minute, 10 minutes, 30 minutes, 4 hours, 8 hours, 12 hours, 24 hours.

In some other examples, the waste sorting robot 100 comprises a moisture sensor (not shown) on the conveyor 110. The moisture sensor can detect whether the waste objects 106 are wet and leaving moisture on the conveyor 110. If the controller 200 determines that the conveyor 110 has been dry for more than a predetermined period of time, then the controller 200 initiates the cleaning solvent cleaning operation.

In some other examples, the controller 200 receives environmental data, for example weather data. The controller 200 determines whether there is rain forecast within a predetermined period of time when the waste sorting robot 100 is in operation. For example, if the controller 200 determines that rain is not forecast in the location of the waste sorting robot 100 for more than 3 days, the controller 200 initiates the cleaning solvent cleaning operation.

In some examples, one or more of the triggers can be used by the controller 200 to determine whether to initiate the cleaning solvent cleaning operation. In some other examples, any suitable information can be used by the controller 200 to determine whether to initiate the cleaning solvent cleaning operation.

When the controller 200 initiates the cleaning operation, the controller 200 sends a control instruction to move the suction gripper 120 as shown in step 1008. In this way, the controller 200 sends a control instruction to the manipulator 104 to move the suction gripper 120 from the first position to the second position.

The controller 200 then sends a control instruction to actuate the cleaning solvent valve 228 according to step 1006. The cleaning solvent outlet 222 then sprays cleaning solvent outside the suction gripper 120 as shown in step 1012. Accordingly, the suction gripper 120 comes into contact with the cleaning solvent in the second position. In some examples, moving the suction gripper 120 into the second position comprises moving the suction gripper 120 in front of the cleaning solvent outlet 222. This means the suction gripper 120 is sprayed with cleaning solvent.

In some examples, the step of moving the suction gripper 120 can be carried out during the step 1012 of spraying the cleaning solvent.

In some other examples, moving the suction gripper 120 into the second position comprises performing a picking operation on a waste object 106 coated with cleaning solvent. In this way, the second position is a suction gripper 120 position in contact with a waste object 106. The waste object 106 is used to convey the cleaning solvent to the suction gripper 120. Normal operation of the suction gripper 120 ensures that at least some of the cleaning solvent will clean the suction gripper 120.

In some other examples, moving the suction gripper 120 into the second position comprises submerging at least a portion of the suction gripper 120 into the cleaning solvent e.g., in the cleaning solvent container 800 as shown in step 1010.

Whilst the controller 200 initiates the cleaning solvent cleaning operation, the controller 200 can modify the flow rate of the cleaning solvent at the cleaning solvent outlet 222 and modify the duration of the cleaning solvent dosing operation. The controller 200 can modify the cleaning solvent cleaning operation in dependence of one of more parameters of the waste sorting robot 100.

By periodically spraying or coating the outer surface of the suction gripper 120, the build-up of dirt and debris can be reduced. This means that the waste sorting robot 100 requires less maintenance and is more efficient.

In another example two or more examples are combined. Features of one example can be combined with features of other examples.

Examples of the present invention have been discussed with particular reference to the examples illustrated. However it will be appreciated that variations and modifications may be made to the examples described within the scope of the invention.

1. A waste sorting robot comprising:
a manipulator moveable within a working area;
a suction gripper connected to the manipulator and arranged to generate a negative pressure to selectively grip a waste object in the working area; and
a cleaning solvent supply external to the suction gripper;
wherein the suction gripper is configured to move from a first position remote from the cleaning solvent supply to a second position in which the cleaning solvent supply contacts the suction gripper.

2. The waste sorting robot according to claim 1 wherein the cleaning solvent supply is an open container and the suction gripper is configured to lower from the first position above the open container to a second position in which at least part of the suction gripper is submerged in the cleaning solvent supply.

3. The waste sorting robot according to claim 2 wherein the open container is mounted to the waste sorting robot.

4. The waste sorting robot according to claim 3 wherein the open container is mounted to a frame of the waste sorting robot or to a chute configured to receive sorted waste objects.

5. The waste sorting robot according to claim 1 wherein the cleaning solvent supply is in fluid communication with at least one first cleaning nozzle configured to spray cleaning solvent droplets and the suction gripper is configured to move from the first position remote from the cleaning solvent droplets to a second position in contact with the cleaning solvent droplets.

6. The waste sorting robot according to claim 5 wherein the at least one first cleaning nozzle is configured to spray at least part of the working area.

7. The waste sorting robot according to claim 5 wherein the at least one first cleaning nozzle is configured to spray one or more objects before the one or more objects enter the working area.

8. The waste sorting robot according to claim 1 wherein the cleaning solvent supply is in fluid communication with at least one second cleaning nozzle configured to spray cleaning solvent droplets on one or more waste object outside the working area and the suction gripper is configured to move from the first position remote from the cleaning solvent droplets to a second position in contact with the waste object and cleaning solvent droplets.

9. A waste sorting robot comprising:
a manipulator moveable within a working area;
a suction gripper connected to the manipulator and arranged to generate a negative pressure to selectively grip a waste object in the working area; and
a cleaning solvent supply in fluid communication with a cleaning solvent outlet, wherein the cleaning solvent outlet is mounted external to the suction gripper.

10. The waste sorting robot according to claim 9 wherein the cleaning solvent outlet is remote from an airflow flow path inside the suction gripper.

11. The waste sorting robot according to claim 9 wherein the cleaning solvent outlet is configured to deliver cleaning solvent to more of the manipulator, the suction gripper or a conveyor.

12. The waste sorting robot according to claim 9 wherein the cleaning solvent outlet is configured to deliver cleaning solvent to the waste object before the waste object enters the working area.

13. The waste sorting robot according to claim 9 wherein the cleaning solvent outlet is in fluid connection with a supply valve configured to selectively supply a cleaning solvent.

14. The waste sorting robot according to claim 9 wherein the cleaning solvent supply is a cleaning solvent tank.

15. A waste sorting robot according to claim 14 wherein the manipulator is mounted on a waste sorting robot frame and the cleaning solvent tank is mounted above the suction gripper on the waste sorting robot frame.

16. The waste sorting robot according to claim 1 further comprising a cleaning solvent, wherein the cleaning solvent is one or more of water, ethanol, methanol, ammonia, or acetone.

17. A waste sorting robot according to claim 1 further comprising a cleaning solvent, wherein the cleaning solvent comprises one or more additives.

18. A waste sorting robot according to claim 17 wherein the one or more additives is one or more of a disinfectant, a surfactant, a detergent, or a dispersant.

19. A method of controlling a waste sorting robot comprising:
moving a manipulator within a working area;
controlling a suction gripper connected to the manipulator to generate a negative pressure to selectively grip a waste object in the working area;
moving the suction gripper from a first position remote from a cleaning solvent supply to a second position; and
supplying the suction gripper with the cleaning solvent supply when the suction gripper is in the second position such that the cleaning solvent supply contacts the suction gripper.

20. (canceled)

21. (canceled)
